(19) United States
(12) Patent Application Publication
(10) Pub. No.: US 2002/0036092 A1
(43) Pub. Date: Mar. 28, 2002

(54) Overhead cable

(76) Inventors: Naoshi Kikuchi, Tochigi (JP); Kinya Kawabata, Mie (JP); Teruhiro Yukino, Hyogo (JP); Hirotaka Ishida, Hyogo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/881,256

(22) Filed: Jun. 14, 2001

(30) Foreign Application Priority Data
Jun. 15, 2000 (JP) 2000-180263

(51) Int. Cl. H02G 7/00

(52) U.S. Cl. 174/40 R

(57) ABSTRACT

An overhead cable wherein a sectional shape of an outer circumferential surface formed by outermost members is a polygon inscribing a circle of a diameter d (mm), sides of the polygon are formed as substantially flat surfaces connecting adjoining vertexes, vertexes of the polygon inscribing the circle are cut away to form arc-shaped grooves having a radius R (mm) and having a depth H (mm) from the vertexes, and the arc-shaped grooves are formed in spirals in the outer circumference of the overhead cable in a longitudinal direction of the overhead cable at predetermined pitches, the diameter d of the overhead cable being in a range of 18 to 52 (mm), and the outer circumferential surface formed by the outermost members being formed so that a number N of vertexes of the polygon and the diameter d satisfy a condition defined by the following formula:

N=(13.0+0.092d+0.0031d²) rounded off

the depth H of an arc-shaped groove and the diameter d satisfy a condition defined by the following formula:

0.00543d≦H≦0.00865d

and

the radius R of an arc-shaped groove and the depth H satisfy a condition defined by the following formula:

4.960H≦R≦8.802H

### BACKGROUND OF THE INVENTION

1. Field of the Invention

The present invention relates to an overhead cable such as an overhead power cable or an overhead ground wire, more particularly relates to an overhead cable with little wind load under conditions where both strong wind and rainfall are simultaneously present such as during a typhoon.

2. Description of the Related Art

In the past, much use has been made of steel-reinforced aluminum cable (ACSR) comprised of aluminum strands twisted around steel strands for overhead power cables. In this type of overhead power cable, the following overhead cables are known for reducing the wind load.

(1) Overhead cables obtained by twisting aluminum strands around steel strands, twisting segment strands of a fan-shaped cross-section at the outermost layer, forming corners of the segment strands into outwardly projecting arc shapes, and setting the radius of curvature of the corner arc-shaped surfaces to a specific value to reduce the wind load

(2) Overhead cables given wavy surfaces at the outermost layer to reduce the wind load

(3) Overhead cables obtained by twisting segment strands of a fan-shaped cross-section at the outermost layer and providing arc-shaped grooves at the surface side of the adjoining parts of the segment strands to reduce the wind load

(4) Overhead cables given sectional shapes of regular polygons and provided with arc-shaped grooves at the vertexes to reduce the wind load

However, when these overhead cables were subjected to wind tunnel tests providing a grid for generating drops of water for simulating the state of rainfall on these overhead cables in the wind tunnel and reproducing wind of a wind speed of 40 m/sec and rainfall of an amount of 16 mm/10 min, it was found that the drops of water due to the rainfall deposited on the surface of the overhead cables resulting in a surface shape of the cables remarkably different from the surface shape envisioned at the time of design.

That is, the drops of water deposited on the surface of the overhead cables due to rainfall moved on the surface from the upwind side to the downwind side to finally reach the breakaway point of the air, but the flow of air at the breakaway point is weak, so the drops of water remained at that position and merged to form reservoirs of water like water channels at the surface of the overhead cables.

As a result, the drag coefficient of an overhead cable obtained by tests reproducing strong wind and rainfall in a wind tunnel clearly becomes larger than the drag coefficient of an overhead cable obtained by an ordinary wind tunnel test, that is, a test reproducing only strong wind. Therefore, a conventional overhead cable suffers from the problem that a sufficient effect of reduction of the drag coefficient cannot be obtained under conditions of a strong wind and rainfall as at the time of a typhoon.

### SUMMARY OF THE INVENTION

An object of the present invention is to provide an overhead cable able to reduce the wind load not only at the time of strong wind, but also strong wind and rainfall.

To achieve this object, according to the present invention, there is provided an overhead cable wherein a sectional shape of an outer circumferential surface formed by outermost members is a polygon inscribing a circle of a diameter d (mm), sides of the polygon are formed as substantially flat surfaces connecting adjoining vertexes, vertexes of the polygon inscribing the circle are cut away to form arc-shaped grooves having a radius R (mm) and having a depth H (mm) from the vertexes, and the arc-shaped grooves are formed in spirals in the outer circumference of the overhead cable in a longitudinal direction of the overhead cable at predetermined pitches, the diameter d of the overhead cable being in a range of 18 to 52 mm, and the outer circumferential surface formed by the outermost members being formed so that a number N of vertexes of the polygon and the diameter d satisfy a condition defined by the following formula 1:

N=(13.0+0.092d+0.0031d²) rounded off (1)

the depth H of an arc-shaped groove and the diameter d satisfy a condition defined by the following formula 2:

0.00543d≦H≦0.00865d (2)

and

the radius R of an arc-shaped groove and the depth H satisfy a condition defined by the following formula 3:

4.960H≦R≦8.802H (3)

The ability to reduce the wind load at the time of strong wind and rainfall by the above configuration is clear from the results of wind tunnel tests reproducing strong wind and rainfall for overhead cables of various sectional shapes.

### BRIEF DESCRIPTION OF THE DRAWINGS

These and other objects and features of the present invention will become clearer from the following description of the preferred embodiments given with reference to the accompanying drawings, in which:

FIG. 1 is a sectional view of an overhead power cable as a first embodiment of an overhead cable according to the present invention, and FIG. 2 is a partial enlarged view of the overhead power cable illustrated in FIG. 1.

### DESCRIPTION OF THE PREFERRED EMBODIMENTS

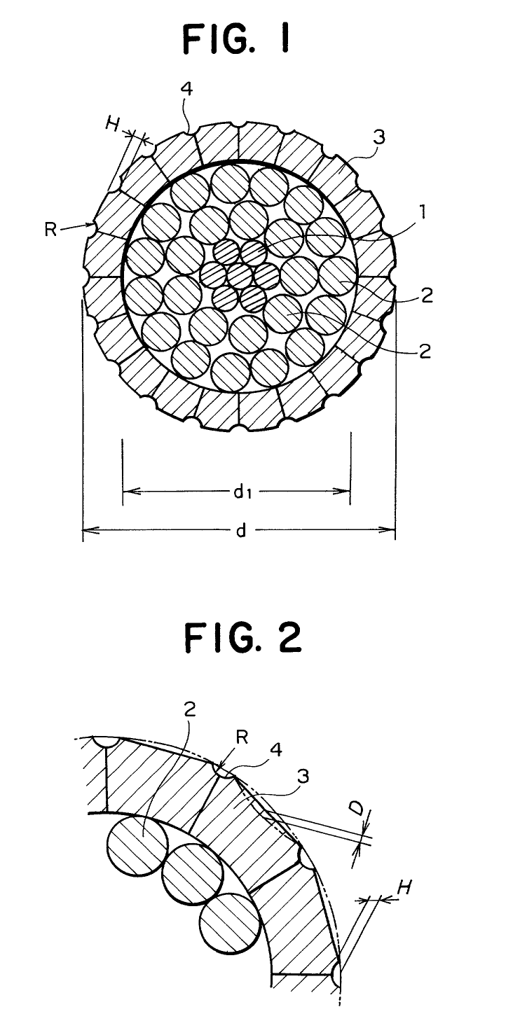

An overhead power cable will be explained with reference to FIG. 1 and FIG. 2 as a first embodiment of an overhead cable of the present invention.

The overhead power cable illustrated in FIG. 1 and FIG. 2 is comprised of, at the center seven steel strands 1 having circular sectional shapes and twisted by a predetermined pitch in the longitudinal direction of the overhead power cable, around the seven twisted steel strands 1, nine first aluminum strands 2A having circular sectional shapes and twisted by a predetermined pitch in the longitudinal direction of the overhead power cable, around the first aluminum strands 2A, 15 second aluminum strands 2B having circular sectional shapes and twisted by a predetermined pitch in the longitudinal direction of the overhead power cable, and, around the second aluminum strands 2B, 20 aluminum segment strands 3. The aluminum strands 3 correspond to the outermost members of the present invention.

The configuration and shape of the outermost aluminum strands 3 will be explained next. The shape of a segment strand 3 is obtained by dividing a ring having an inner circular surface of a diameter d1, an outer polygonal surface inscribing a circle of an outside diameter d (d>d1), and a thickness from the inner circular surface to the outer circle of (d−d1)/2 into equal parts, 20 in this embodiment, at the vertexes of the polygon. The inner circumferential surface of each segment therefore constitutes part of a circle of a diameter d1, while the outer circumferential surface connects the adjoining vertexes, is substantially parallel to the inner circumferential surface, and is formed flat or is formed slightly depressed from the flat surface by a depression D (mm), for example, as illustrated in Table 1 (hereinafter referred to as “substantially flat”, in Table 1, flat being indicated by D=0). The two corners of the substantially flat outer circumferential surface are cut away to form semi-arc-shaped grooves of a radius R (mm) and a depth H (mm) from the vertexes. That is, each segment strand 3 has a substantially trapezoidal cross-section.

When these segment strands are made to adjoin each other, the adjoining arc-shaped grooves are formed as single arc-shaped grooves 4.

There are 20 segment strands 3 in this embodiment. These 20 segment strands are arranged adjoining each other so as to cover the outer circumference of the second aluminum strands 2B. A plurality of arc-shaped grooves 4 defined by the adjoining segment strands 3, 3 circle the overhead power cable in spirals in the longitudinal direction at a predetermined pitch. The state of the arc-shaped grooves 4 circling the cable, however, is not illustrated.

The overhead power cable of FIG. 1 is a steel-reinforced aluminum cable using steel strands 1 at the core and two layers of aluminum strands 2A and 2B and one layer of aluminum segment strands 3 around them, but the sectional shape, configuration, and materials of the overhead cable of the present invention is not limited to the configuration of the overhead cable illustrated in FIG. 1 and FIG. 2. For example, it is also possible to use an aluminum-covered steel strand or aluminum alloy strand as the segment strand 3. Further, the invention may be similarly applied to an aluminum alloy cable, copper cable, overhead ground wire, etc.

### EXAMPLES

Various types of overhead power cables of the sectional shape shown in FIG. 1 differing in the diameter d (mm), number N of vertexes of the regular polygon inscribing a circle of a diameter d defined according to the magnitude of the diameter d, radius R (mm) of arc-shaped grooves 4, and depth H (mm) of arc-shaped grooves 4 from the outer circumferential surface of the outer diameter d (mm) were produced. These examples of overhead power cables are shown in Table 1 as Nos. 1-1 to 1-3, 2-1 to 2-4, 3-1 to 3-4, 4-1 to 4-5, 5-1 to 5-5, 6-1 to 6-5, and 7-1 to 7.5.

The overhead power cables used were steel-reinforced aluminum cables of a diameter of 18 to 52 mm.

These overhead power cables were subjected to wind tunnel tests to measure the drag coefficient at the time of strong wind and rainfall in a range of wind speed of 20 to 40 m/sec and rainfall conditions of 16 mm/10 min.

The maximum wind speed of the tests was set at 40 m/sec since the maximum wind speed used at the time of designing an overhead power cable is usually 40 m/sec. The rainfall condition is a value adopted from records of the wind speed and amount of rainfall of a typhoon measured in the past.

For comparison, ordinary cables with outer circumferential surfaces comprised of not flat, but circular facets and with no arc-shaped grooves (ACSRs with outermost layers comprised of strands of circular cross-sections), shown as Nos. 8-1 to 8-4 in Table 1, were also tested.

The overhead cables produced for the tests were as shown in Table 1. Note that the depression D (mm) of the sides of the regular polygon is the depression from the line connecting one vertex and another (see FIG. 2). The outer circumferential surface of the overhead power cable is comprised of completely flat facets as with D=0 or of facets with some depression as with D=0.10 to 0.20 (mm).

TABLE 1

| | | | | | | Depres- |
|---|---|---|---|---|---|---|
| | | | | Arc-shaped | | sion of |
| | Dia- | Sec- | No. of | groove of | | sides |
| | meter | tional | vertexes | vertex (mm) | | of |
| | d | area | of | Radius | Depth | polygon |
| No. | (mm) | (mm²) | polygon | R | H | (mm) |
| 1-1 | 18 | 160 | 15 | 0.80 | 0.12 | 0 |
| 1-2 | 18 | 160 | 16 | 0.90 | 0.13 | 0 |
| 1-3 | 18 | 160 | 17 | 1.00 | 0.14 | 0 |
| 2-1 | 22 | 240 | 16 | 1.20 | 0.17 | 0 |
| 2-2 | 22 | 240 | 16 | 1.20 | 0.17 | 0.10 |
| 2-3 | 22 | 240 | 16 | 1.20 | 0.17 | 0.20 |
| 2-4 | 22 | 240 | 16 | 0.80 | 0.30 | 0 |
| 3-1 | 28 | 410 | 14 | 1.50 | 0.22 | 0.15 |
| 3-2 | 28 | 410 | 18 | 1.30 | 0.20 | 0 |
| 3-3 | 28 | 410 | 20 | 1.50 | 0.18 | 0 |
| 3-4 | 28 | 410 | 24 | 1.50 | 0.26 | 0 |
| 4-1 | 33 | 610 | 14 | 1.80 | 0.26 | 0 |
| 4-2 | 33 | 610 | 16 | 1.80 | 0.26 | 0.15 |
| 4-3 | 33 | 610 | 18 | 1.80 | 0.22 | 0 |
| 4-4 | 33 | 610 | 20 | 1.40 | 0.24 | 0 |
| 4-5 | 33 | 610 | 22 | 1.40 | 0.18 | 0 |
| 5-1 | 36.6 | 810 | 20 | 1.50 | 0.20 | 0 |
| 5-2 | 36.6 | 810 | 20 | 1.70 | 0.24 | 0 |
| 5-3 | 36.6 | 810 | 22 | 1.60 | 0.24 | 0 |
| 5-4 | 36.6 | 810 | 24 | 1.80 | 0.30 | 0 |
| 5-5 | 36.6 | 810 | 24 | 2.50 | 0.30 | 0 |
| 6-1 | 46 | 1160 | 20 | 1.24 | 0.25 | 0.10 |
| 6-2 | 46 | 1160 | 22 | 1.80 | 0.25 | 0 |
| 6-3 | 46 | 1160 | 22 | 2.20 | 0.25 | 0 |
| 6-4 | 46 | 1160 | 24 | 2.40 | 0.35 | 0 |
| 6-5 | 46 | 1160 | 28 | 1.80 | 0.28 | 0 |
| 7-1 | 52 | 1520 | 26 | 2.50 | 0.36 | 0 |
| 7-2 | 52 | 1520 | 28 | 2.50 | 0.38 | 0 |
| 7-3 | 52 | 1520 | 30 | 2.40 | 0.45 | 0 |
| 7-4 | 52 | 1520 | 32 | 2.40 | 0.45 | 0 |
| 7-5 | 52 | 1520 | 32 | 2.40 | 0.20 | 0 |

| | | | |
|---|---|---|---|
| 8-1 | 22.4 | 240 | Ordinary ACSR |
| 8-2 | 28.5 | 410 | Ordinary ACSR |
| 8-3 | 38.4 | 810 | Ordinary ACSR |
| 8-4 | 46.2 | 1160 | Ordinary ACSR |

The results of measurement of the drag coefficient for these overhead power cables under conditions of a wind speed of 40 m/sec and no rainfall and the drag coefficient under conditions of a wind speed of 40 m/sec and a rainfall strength of 16 mm/10 minutes are shown in Table 2.

The values of H/d and H/R of the overhead power cables for which an effect of reduction of the drag coefficient was recognized at the time of rainfall are shown together in Table 2.

Note that as to the method of expression of the drag coefficient at the time of rainfall, the constant used when finding the drag coefficient is obtained by using the value and equation at the time of no rainfall. Therefore, if stopping rainfall and measuring the drag by a drag measuring apparatus at the time of rainfall, the drag coefficient at an ordinary wind speed of 40 m/sec is found. In other words, the drag coefficient at the time of rainfall directly expresses the change in the load applied to the overhead power cable due to the effect of rainfall. In the evaluation at the time of rainfall in Table 2, “large effect” means a drag coefficient of less than 0.75, “medium effect” means a drag coefficient of from 0.75 to less than 0.80, “small effect” means a drag coefficient of from 0.80 to less than 0.85, and “no effect” means a drag coefficient of from 0.85.

TABLE 2

| | | Drag | | | |
|---|---|---|---|---|---|
| | | coeffi- | | | |
| | Drag | cient at | | | |
| | coeffi- | time of | | | |
| | cient at | wind | | | |
| | time of | speed of | | | |
| | wind speed | 40 m/sec | | | |
| | of 40 | and | | | |
| | m/sec and | rainfall | Evaluation at | | |
| | no | of 16 | time of | | |
| No. | rainfall | mm/10 mm | rainfall | H/d | H/R |
| 1-1 | 0.962 | 0.877 | No effect | | |
| 1-2 | 0.958 | 0.823 | Small effect | 0.00722 | 0.1444 |
| 1-3 | 0.971 | 0.842 | Small effect | 0.00778 | 0.1400 |
| 8-1 | 0.956 | 0.996 | | | |
| 2-1 | 0.811 | 0.788 | Medium effect | 0.00773 | 0.1417 |
| 2-2 | 0.782 | 0.792 | Medium effect | 0.00773 | 0.1417 |
| 2-3 | 0.751 | 0.814 | Medium effect | 0.00770 | 0.1417 |
| 2-4 | 0.842 | 0.882 | No effect | | |
| 8-2 | 0.981 | 1.021 | | | |
| 3-1 | 0.722 | 0.794 | Medium effect | 0.00786 | 0.1467 |
| 3-2 | 0.724 | 0.763 | Medium effect | 0.00714 | 0.1538 |
| 3-3 | 0.763 | 0.776 | Medium effect | 0.00643 | 0.1200 |
| 3-4 | 0.812 | 0.872 | No effect | | |
| 4-1 | 0.824 | 0.915 | No effect | | |
| 4-2 | 0.758 | 0.822 | Small effect | 0.00788 | 0.1444 |
| 4-3 | 0.729 | 0.781 | Medium effect | 0.00667 | 0.1222 |
| 4-4 | 0.654 | 0.754 | Medium effect | 0.00727 | 0.1714 |
| 4-5 | 0.651 | 0.784 | Medium effect | 0.00545 | 0.1286 |
| 8-3 | 0.897 | 1.037 | | | |
| 5-1 | 0.721 | 0.762 | Medium effect | 0.00546 | 0.1333 |
| 5-2 | 0.564 | 0.739 | Large effect | 0.00656 | 0.1412 |
| 5-3 | 0.637 | 0.771 | Medium effect | 0.00656 | 0.1500 |
| 5-4 | 0.728 | 0.817 | Small effect | 0.00820 | 0.1200 |
| 5-5 | 0.739 | 0.918 | No effect | | |
| 8-4 | 0.952 | 0.989 | | | |
| 6-1 | 0.723 | 0.772 | Medium effect | 0.00543 | 0.2016 |
| 6-2 | 0.698 | 0.767 | Medium effect | 0.00543 | 0.1389 |
| 6-3 | 0.657 | 0.745 | Large effect | 0.00543 | 0.1136 |
| 6-4 | 0.712 | 0.740 | Large effect | 0.00761 | 0.1458 |
| 6-5 | 0.841 | 0.862 | No effect | | |
| 7-1 | 0.722 | 0.785 | Medium effect | 0.00692 | 0.1440 |
| 7-2 | 0.784 | 0.817 | Small effect | 0.00731 | 0.1520 |
| 7-3 | 0.791 | 0.824 | Small effect | 0.00865 | 0.1875 |
| 7-4 | 0.792 | 0.818 | Small effect | 0.00865 | 0.1875 |
| 7-5 | 0.768 | 0.860 | No effect | | |
| | | | Maximum | 0.00543 | 0.1136 |
| | | | Minimum | 0.00865 | 0.2016 |

The following will be understood from the results of Table 2:

(1) Overhead power cables of size of diameter of 18 mm (Nos. 1-1 to 1-3): Reduction occurs in drag coefficient at time of rainfall. However, the effect can be judged to be small.

(2) Overhead power cables of size of diameter of 18 mm (Nos. 2-1 to 2-4): Reduction occurs in drag coefficient at time of rainfall compared with 0.956 drag coefficient of ordinary ACSR (No. 8-1) of the same size. The relationship of the depression D of the portions at the sides of the regular polygon and the drag coefficient was investigated for overhead power cables of this size, but there was no remarkable difference in the drag coefficient between when there were depressions and there weren't. Rather, a tendency toward a lower drag coefficient the smaller the depression D was observed. Since a result of under 0.8 was obtained with the overhead power cable of the smallest drag coefficient at the time of rainfall, the effectiveness of the cross-sectional shape of the overhead power cable according to this embodiment of the present invention could be confirmed. However, the effect can be judged to be medium.

(3) Overhead power cables of size of diameter of 28 mm (Nos. 3-1 to 3-4): The number N of vertexes of the polygon was made different for overhead power cables of this size. Reduction occurs in drag coefficient at time of rainfall compared with 0.981 drag coefficient of ordinary ACSR (No. 8-2) of the same size. However, the effect can be judged to be medium.

(4) Overhead power cables of size of diameter of 33 mm (Nos. 4-1 to 4-5): Reduction occurs in drag coefficient at time of rainfall. However, the effect can be judged to be medium.

(5) Overhead power cables of size of diameter of 36.6 mm (Nos. 5-1 to 5-5): Reduction occurs in drag coefficient at time of rainfall. The biggest effect was with a drag coefficient of 0.739. Compared with the drag coefficient of 1.037 of an ordinary ACSR (No. 8-3) of the same size, a 28.7% reduction in the drag coefficient could be observed.

(6) Overhead power cables of size of diameter of 46 mm (Nos. 6-1 to 6-5): Reduction occurs in drag coefficient at time of rainfall. The biggest effect was with a drag coefficient of 0.740. Compared with the drag coefficient of 1 of an ordinary ACSR (No. 8-4) of the same size, a 25% reduction in the drag coefficient could be observed.

(7) Overhead power cables of size of diameter of 52 mm (Nos. 7-1 to 7-5): Reduction occurs in drag coefficient at time of rainfall. However, the effect can be judged to be small.

The overhead power cables giving the best effects of reduction of the drag coefficient in the different sizes found from the above experiments are summarized in Table 3. The relationships among the number N of vertexes, H/d, and H/R are shown there.

TABLE 3

| | | | Drag | Drag | | | |
|---|---|---|---|---|---|---|---|
| | | | coefficient | coefficient | | | |
| | | No. of | at wind speed | at wind speed | | | |
| | Diameter | vertex- | of 40 m/s and | of 40 m/s and | Evaluation at | | |
| No. | d (mm) | es | no rainfall | rainfall | time of rainfall | H/d | H/R |
| 1-2 | 18 | 16 | 0.958 | 0.823 | Small effect | 0.00722 | 0.1444 |
| 2-1 | 22 | 16 | 0.811 | 0.788 | Medium effect | 0.00773 | 0.1417 |
| 3-2 | 28 | 18 | 0.724 | 0.763 | Medium effect | 0.00714 | 0.1538 |
| 4-4 | 33 | 20 | 0.654 | 0.754 | Medium effect | 0.00727 | 0.1714 |
| 5-2 | 36.6 | 20 | 0.564 | 0.739 | Large effect | 0.00656 | 0.1412 |
| 6-4 | 46 | 24 | 0.712 | 0.740 | Large effect | 0.00761 | 0.1458 |
| 7-1 | 52 | 26 | 0.722 | 0.785 | Medium effect | 0.00692 | 0.1440 |
| | | | | | Minimum | 0.00656 | 0.1412 |
| | | | | | Maximum | 0.00773 | 0.1714 |
| | | | | | Average | 0.00721 | 0.1489 |

A strong correlation is observed when viewing the diameter d of the overhead power cable and the number N of vertexes of Table 3. That is, the formula for finding the number N of vertexes from the diameter d can be expressed as follows:

N=(13.0+0.092d+0.0031d²) rounded off

Further, the relationship of the depth H of the arc-shaped groove of each vertex with respect to the diameter d of the overhead power cable is considered to be substantially constant if viewing the values of H/d of Table 3. Therefore, desirable values of the effective range and average value can be obtained from the minimum value to maximum value of H/d in Table 3.

That is, the minimum value of the depth H of the arc-shaped grooves become as follows from H/d=0.00656:

H=0.00656d

The maximum value of the depth H of the arc-shaped grooves become as follows from H/d=0.00773: H=0.00773d The average value of the depth H of the arc-shaped grooves become as follows from H/d=0.00721: H=0.00721d

Depths H of the arc-shaped grooves 4 satisfying these dimensional conditions can be said to be the effective range.

If the depth H of the arc-shaped grooves 4 is in this range, a reduction of the drag coefficient of over 20% compared with an ordinary overhead power cable can be achieved, but if the range of the depth H of the arc-shaped grooves which enables achievement of a reduction of the drag coefficient of over 15% is found in the same way from the value of Table 2, the following are obtained:

Minimum value H=0.00543d

Maximum value H=0.00865d

That is, the effect of reduction of the drag coefficient can be obtained in this range as well.

Next, the relationship between the depth H and the radius R of the arc-shaped groove of each vertex is considered to be substantially constant when viewing the value of H/R of Table 3. Therefore, desirable values of the effective range and average value can be obtained from the minimum value to maximum value of H/R in Table 3. That is, the values of the radius R of the arc-shaped grooves become as follows:

Minimum value of radius R of arc-shaped grooves: R=5.834H from H/R=0.1714

Maximum value of radius R of arc-shaped grooves: R=7.082H from H/R=0.1412

Average value of radius R of arc-shaped grooves: R=6.716H from H/R=0.1489

The above can be said to shown the effective range of the radius R of the arc-shaped grooves.

The above range represents values which enable achievement of a reduction of the drag coefficient of over 20% compared with an ordinary overhead power cable, but if the range of the radius R of the arc-shaped grooves which enables achievement of a reduction of the drag coefficient of over 15% is found in the same way from the value of Table 2, the following are obtained:

Minimum value R=4.960H

Maximum value R=8.802H

That is, the effect of reduction of the drag coefficient can be obtained in this range as well.

Next, regarding the depression D of the portion of the sides of the cross-section of a regular polygonal overhead power cable, according to Table 2, no effect of reduction of the drag coefficient due to the presence of D can be observed under rainfall conditions. Rather, the effect of reduction of the drag coefficient is greater when D=0, so the depression is preferably made D=0. Therefore, when producing a segment strand for the outermost layer, the surface of the strand at the outside is preferably flat even considering deformation due to three-dimensional bending at the time of twisting.

The above embodiment shows the results of a study on a steel-reinforced aluminum cable, but the present invention relates to the surface shape of an overhead power cable. Therefore, similar effects are obtained, regardless of the material of the overhead power cable, even if applied to a steel overhead cable, an overhead ground wire comprised of steel strands, a power distribution cable, etc.

Further, similar effects can be obtained even if using a composite strand comprised of fine strands of Invar wire, silicon carbide filaments, carbon fiber, alumina fiber, or high strength organic fiber (aramide fiber etc.) plated or covered on the surface by aluminum, zinc, chrome, copper, etc. instead of the steel cores serving as the main tension-bearing members of the overhead power cable.

Further, since the outermost layer strands are effectively positioned, the present invention may also be applied to a cable using segment strands structured so that adjoining outermost layer strands mesh with each other.

Further, the segment strands 3, as mentioned above, need only form the polygonal shape. There is no need for them to be divided into the plurality of segment strands as illustrated in FIG. 1 and FIG. 2.

As explained above, according to the present invention, it is possible to obtain an overhead power cable with a small wind load not only at the time of strong wind, but also strong wind and rainfall. Therefore, it is possible to reduce the strength required in a support structure of an overhead cable and possible to reduce the cost of an overhead cable line.

What is claimed is:

1. An overhead cable wherein a sectional shape of an outer circumferential surface formed by outermost members is a polygon inscribing a circle of a diameter d (mm), sides of the polygon are formed as substantially flat surfaces connecting adjoining vertexes, vertexes of the polygon inscribing the circle are cut away to form arc-shaped grooves having a radius R (mm) and having a depth H (mm) from the vertexes, and the arc-shaped grooves are formed in spirals in the outer circumference of the overhead cable in a longitudinal direction of the overhead cable at predetermined pitches, the diameter d of the overhead cable being in a range of 18 to 52 (mm), and the outer circumferential surface formed by the outermost members being formed so that a number N of vertexes of the polygon and the diameter d satisfy a condition defined by the following formula 1:
N=(13.0+0.092d+0.0031d²) rounded off (1)
the depth H of an arc-shaped groove and the diameter d satisfy a condition defined by the following formula 2:
0.00543d≦H≦0.00865d (2)
and
the radius R of an arc-shaped groove and the depth H satisfy a condition defined by the following formula 3:
4.960H≦R≦8.802H (3)

2. An overhead cable as set forth in claim 1, wherein the outer circumferential surface formed by the outermost members being formed so that
the depth H of an arc-shaped groove of the polygon and the diameter d satisfy a condition defined by the following formula 2-1:
0.00656d≦H≦0.00773d (2-1)

3. An overhead cable as set forth in claim 1, wherein the outer circumferential surface formed by the outermost members being formed so that
the radius R of an arc-shaped groove and the depth H satisfy a condition defined by the following formula 3-1a:
5.834H≦R≦7.082H (3-1a)

4. An overhead cable as set forth in claim 2, wherein the outer circumferential surface formed by the outermost members being formed so that
the radius R of an arc-shaped groove and the depth H satisfy a condition defined by the following formula 3-1b:
5.834H≦R≦7.082H (3-1b)

5. An overhead cable as set forth in claim 1, wherein the outer circumferential surface formed by the outermost members being formed so that
the depth H of an arc-shaped groove of the polygon and the diameter d satisfy a condition defined by the following formula 2-2a:
H=0.00721d (2-2a)

6. An overhead cable as set forth in claim 3, wherein the outer circumferential surface formed by the outermost members being formed so that
the depth H of an arc-shaped groove of the polygon and the diameter d satisfy a condition defined by the following formula 2-2b:
H=0.00721d (2-2b)

7. An overhead cable as set forth in claim 4, wherein the outer circumferential surface formed by the outermost members being formed so that
the depth H of an arc-shaped groove of the polygon and the diameter d satisfy a condition defined by the following formula 2-2c:
H=0.00721d (2-2c)

8. An overhead cable as set forth in claim 1, wherein the outer circumferential surface formed by the outermost members being formed so that
the radius R of an arc-shaped groove and the depth H satisfy a condition defined by the following formula 3-2a:
R=6.71H (3-2a)

9. An overhead cable as set forth in claim 2, wherein the outer circumferential surface formed by the outermost members being formed so that
the radius R of an arc-shaped groove and the depth H satisfy a condition defined by the following formula 3-2b:
R=6.71H (3-2b)

10. An overhead cable as set forth in claim 3, wherein the outer circumferential surface formed by the outermost members being formed so that
the radius R of an arc-shaped groove and the depth H satisfy a condition defined by the following formula 3-2c:
R=6.71H (3-2c)

11. An overhead cable as set forth in claim 5, wherein the outer circumferential surface formed by the outermost members being formed so that
the radius R of an arc-shaped groove and the depth H satisfy a condition defined by the following formula 3-2d:
R=6.71H (3-2d)

12. An overhead cable as set forth in claim 6, wherein the outer circumferential surface formed by the outermost members being formed so that
the radius R of an arc-shaped groove and the depth H satisfy a condition defined by the following formula 3-2e:
R=6.71H (3-2e)

13. An overhead cable as set forth in claim 7, wherein the outer circumferential surface formed by the outermost members being formed so that
the radius R of an arc-shaped groove and the depth H satisfy a condition defined by the following formula 3-2f:
R=6.71H (3-2f)

14. An overhead cable as set forth in claim 1, wherein
the outermost members are comprised of a plurality of segments,
each segment is obtained by dividing the polygon at the vertexes, has an inner surface having a partially arc-shaped sectional shape of a radius d1 (mm) (d1<d), has an outer surface having a flat sectional shape connecting the adjoining vertexes, and has two corners of the flat outer surface formed to define a said arc-shaped groove of a radius R and depth H together with the corners of the adjoining segments, and
the plurality of segments being arranged so that they adjoin each other so the corners of the adjoining segments form said arc-shaped grooves and to cover the outer circumference of the members positioned inside them and so that the plurality of arc-shaped grooves circle the overhead cable in spirals in the longitudinal direction at a predetermined pitch.
